(19) United States
(12) Patent Application Publication
(10) Pub. No.: US 2024/0338013 A1
(43) Pub. Date: Oct. 10, 2024

(54) INFORMATION PROCESSING APPARATUS, NON-TRANSITORY COMPUTER-READABLE MEDIUM, AND INFORMATION PROCESSING METHOD

(71) Applicant: Mitsubishi Electric Corporation, Tokyo (JP)

(72) Inventors: Aki KIMURA, Tokyo (JP); Tetsuro SHIDA, Tokyo (JP); Wataru SASAKI, Tokyo (JP)

(73) Assignee: Mitsubishi Electric Corporation, Tokyo (JP)

(21) Appl. No.: 18/292,925

(22) PCT Filed: Aug. 4, 2021
(86) PCT No.: PCT/JP2021/028916

§ 371 Date: Jan. 29, 2024

(51) Int. Cl. G05B 19/418

(52) U.S. Cl. CPC G05B 19/41865; G05B 19/4183

(57) ABSTRACT

A device control apparatus includes a device-information acquiring unit that acquires, from one or more devices, device information indicating at least manipulations performed by a user; a device-information analyzing unit that analyzes the device information to specify a manipulation pattern being a pattern in which the one or more devices are manipulated in a chronological sequence; a user-information acquiring unit that acquires user information indicating a state of the user; and a manipulation-order determining unit that determines an adopted manipulation order as a manipulation order from the manipulation pattern in such a manner that load on the user changes depending on the state of the user, the manipulation order being an order of manipulations to be performed in a chronological sequence on the one or more devices.

### TECHNICAL FIELD

The disclosure relates to an information processing apparatus, a program, and an information processing method.

### BACKGROUND ART

In the past, devices have been controlled in accordance with the life pattern or status of a user by extracting life pattern information characteristic to the user from the user's usage history of the devices and using this lifestyle pattern information. For example, Patent Literature 1 discloses a technique for creating episode data by combining pieces of element data that indicate content related to a specific episode in lifestyle data, a technique for analyzing the relationship between the pieces of element data contained in the episode data, a technique for specifying a lifestyle pattern characteristic to a user on the basis of the relationship between the pieces of element data, and a technique for controlling devices by using the lifestyle pattern of the user.

### PRIOR ART REFERENCE

### Patent Reference

Patent Literature 1: Japanese Patent No. 3744932

### SUMMARY OF THE INVENTION

### Problem to be Solved by the Invention

However, whether or not the control of a device using a lifestyle pattern is desirable for a user depends on the unique personality of the user. Therefore, if the content of the control is determined only by a lifestyle pattern, a specific user may feel that the content of the control is undesirable, and thus may not continue to use the device control service or may experience a decrease in satisfaction with the device control service.

Accordingly, an object of one or more aspects of the disclosure is to enable device control to be determined in consideration of a state of a user using the devices.

### Means of Solving the Problem

An information processing apparatus according to an aspect of the disclosure includes: a device-information acquiring unit configured to acquire device information indicating at least manipulations performed by a user from one or more devices; a device-information analyzing unit configured to analyze the device information to specify a manipulation pattern, the manipulation pattern being a pattern in which the one or more devices are manipulated in a chronological sequence; a user-information acquiring unit configured to acquire user information indicating a state of the user; and a manipulation-order determining unit configured to determine an adopted manipulation order as a manipulation order from the manipulation pattern in such a manner that load on the user changes depending on the state of the user, the manipulation order being an order of manipulations to be performed in a chronological sequence on the one or more devices.

A program according to an aspect of the disclosure causes a computer to function as: a device-information acquiring unit configured to acquire device information indicating at least manipulations performed by a user from one or more devices; a device-information analyzing unit configured to analyze the device information to specify a manipulation pattern, the manipulation pattern being a pattern in which the one or more devices are manipulated in a chronological sequence; a user-information acquiring unit configured to acquire user information indicating a state of the user; and a manipulation-order determining unit configured to determine an adopted manipulation order as a manipulation order from the manipulation pattern in such a manner that load on the user changes depending on the state of the user, the manipulation order being an order of manipulations to be performed in a chronological sequence on the one or more devices.

An information processing method according to an aspect of the disclosure includes: acquiring device information indicating at least manipulations performed by a user from one or more devices; analyzing the device information to specify a manipulation pattern, the manipulation pattern being a pattern in which the one or more devices are manipulated in a chronological sequence; acquiring user information indicating a state of the user; and determining an adopted manipulation order as a manipulation order from the manipulation pattern in such a manner that load on the user changes depending on the state of the user, the manipulation order being an order of manipulations to be performed in a chronological sequence on the one or more devices.

### Effects of the Invention

According to one or more aspects of the disclosure, device control can be determined in consideration of a state of a user using the device.

### BRIEF DESCRIPTION OF THE DRAWINGS

FIG. 1 is a block diagram schematically illustrating a configuration of a device control system including a device control apparatus according to first and second embodiments.

FIG. 2 is a schematic diagram illustrating examples of devices, device information, and sensors.

FIG. 3 is a block diagram illustrating a configuration of the device control apparatus according to the first embodiment.

FIG. 4 is a schematic diagram illustrating an example of event information.

FIGS. 5A and 5B are graphs illustrating the number of times a device is manipulated to turn the device on or off during each predetermined hour in a predetermined time period when the device is an EcoCute heat pump.

FIGS. 6A and 6B are graphs illustrating the number of times a device is manipulated to turn the device on or off during each predetermined hour when the device is a cooking heater.

FIGS. 7A and 7B are graphs illustrating the operating time of an EcoCute heat pump and a cooking heater.

FIG. 8 is a table showing the probability of the manipulations of devices being linked to each other.

FIG. 9 is an example illustrating a movement line between devices.

FIG. 10 is a schematic diagram illustrating an example of movement-line information.

FIG. 11 is a schematic diagram illustrating an example of user information consisting of user attributes and user detection values.

FIG. 12 is a block diagram illustrating an example computer.

FIG. 13 is a flowchart illustrating processing executed by a device-information acquiring unit and a device-information analyzing unit.

FIG. 14 is a flowchart illustrating processing executed by a movement-line-distance specifying unit.

FIG. 15 is a flowchart illustrating processing executed by a user-information acquiring unit and a manipulation-order determining unit.

FIG. 16 is block a diagram illustrating a configuration of the device control apparatus according to the second embodiment.

FIG. 17 is a block diagram illustrating a configuration of a device control apparatus according to a third embodiment.

FIG. 18 is a schematic diagram illustrating an example of environmental information.

### MODE FOR CARRYING OUT THE INVENTION

### First Embodiment

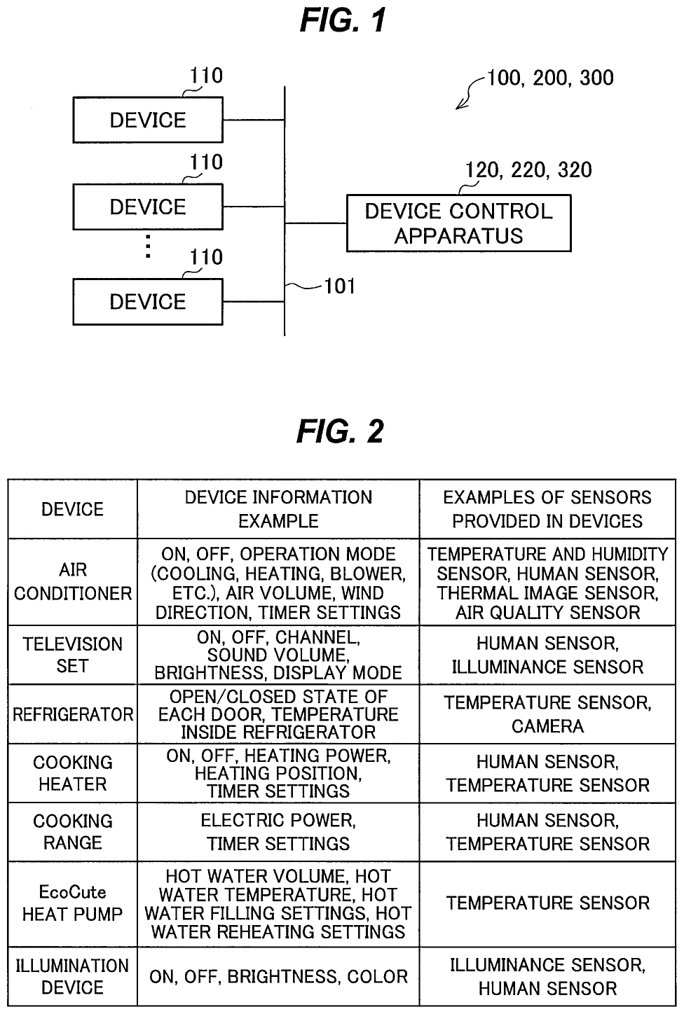

FIG. 1 is a block diagram schematically illustrating a configuration of a device control system 100 including a device control apparatus 120 according to the first embodiment.

The device control system 100 as an information processing system includes one or more devices 110 and the device control apparatus 120.

The devices 110 and the device control apparatus 120 are connected to a network 101.

The network 101 may be wired or wireless. The network 101 may be any one of a local area network (LAN), a wide area network (WAN), and the Internet.

The devices 110 are controlled by the device control apparatus 120. For example, the devices 110 are home appliances such as air conditioners, television sets, refrigerators, cooking heaters, cooking ranges, EcoCute heat pumps, and illumination devices.

The devices 110 can be connected to the network 101 and transmit device information consisting of state information and sensor information to the device control apparatus 120 via the network 101. The device information needs only to contain at least state information.

The state information indicates, for example, a manipulation status of a manipulation performed by a user, which includes, for example, an on or off state of the devices 110, a setting status indicating the settings of the devices 110, or an operating status of the operating devices 110. Here, the state information indicates at least the manipulation status.

The sensor information indicates content detected by sensors provided in the devices 110, such as temperature and humidity sensors, human sensors, illuminance sensors, and open/close sensors.

The sensor information may not be included in the device information. Therefore, no sensors need to be available. Alternatively, multiple sensors may be available.

FIG. 2 is a schematic diagram illustrating examples of the devices 110, the device information, and the sensors.

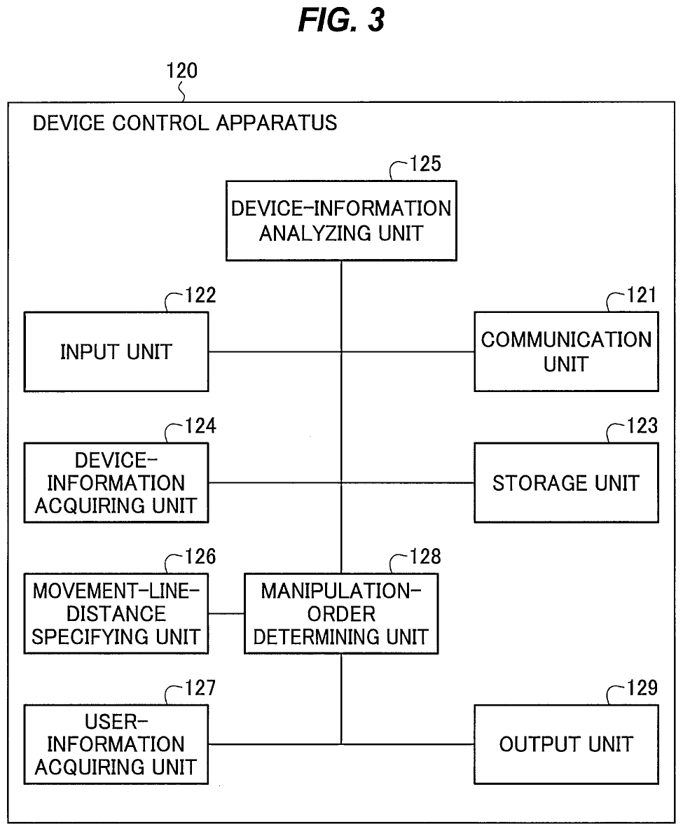

FIG. 3 is a block diagram illustrating a configuration of the device control apparatus 120 according to the first embodiment.

The device control apparatus 120 is an information processing apparatus including a communication unit 121, an input unit 122, a storage unit 123, a device-information acquiring unit 124, a device-information analyzing unit 125, a movement-line-distance specifying unit 126, a user-information acquiring unit 127, a manipulation-order determining unit 128, and an output unit 129.

The communication unit 121 performs communication via the network 101.

The input unit 122 accepts input. For example, the input unit 122 accepts input from a user of the devices 110.

The storage unit 123 stores information and programs necessary for processing executed by the device control apparatus 120.

The device-information acquiring unit 124 acquires device information from the devices 110 via the communication unit 121. The acquired device information is given to the device-information analyzing unit 125.

The device-information analyzing unit 125 analyzes the device information to specify a manipulation pattern that is a pattern in which the devices 110 are manipulated in a chronological sequence.

For example, the device-information analyzing unit 125 analyzes device information to specify events and the time of the events, and stores device identification information, which is identification information for identifying devices 110 and event information indicating the events and the time of the events in the storage unit 123. Here, the device identification information is the names of devices, but is not limited to the names of devices. An event is a change in status indicated by device information; and the device-information acquiring unit 124 should give the post-change status as an event to the device-information analyzing unit 125.

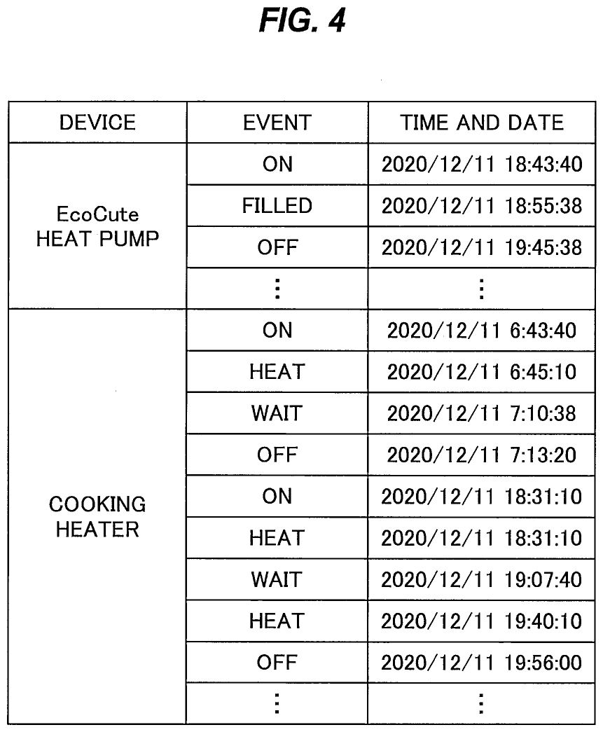

FIG. 4 is a schematic diagram illustrating an example of the event information.

The device-information analyzing unit 125 specifies a manipulation pattern for each device 110 by referring to the event information stored in the storage unit 123 and aggregating the number of times each device 110 has been manipulated during predetermined hours in a predetermined time period. The device-information analyzing unit 125 stores in the storage unit 123 manipulation pattern information indicating the specified manipulation patterns for the respective devices 110.

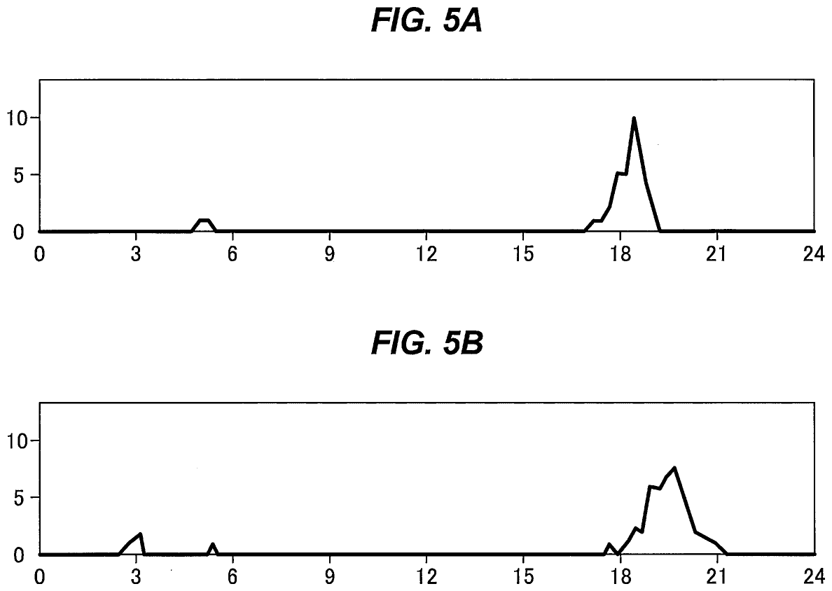

FIGS. 5A and 5B are graphs illustrating the number of times a device 110 is manipulated to turn the device on or off during each predetermined hour in a predetermined time period when the device 110 is an EcoCute heat pump.

FIG. 5A is a graph illustrating the number of times an ON manipulation has been performed during each predetermined hour, and FIG. 5B is a graph illustrating the number of times an OFF manipulation has been performed during each predetermined hour.

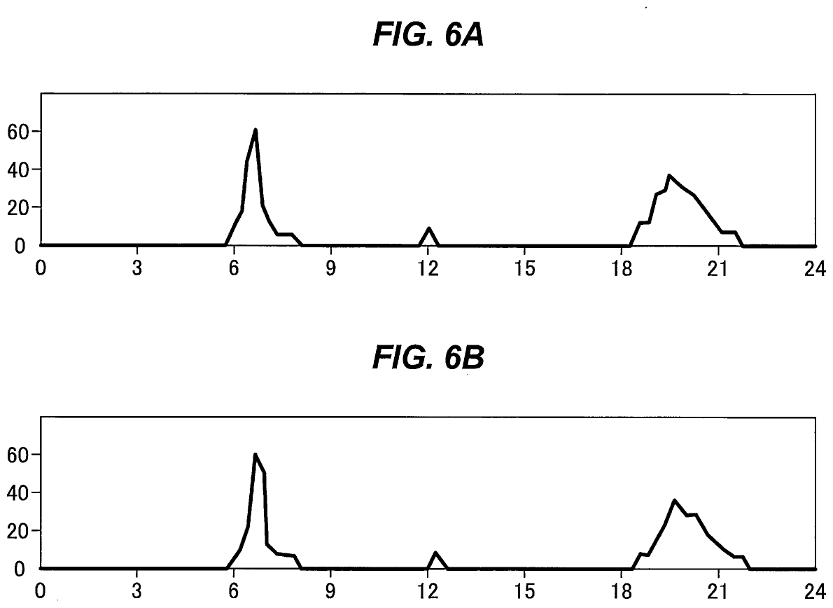

FIGS. 6A and 6B are graphs illustrating the number of times a device is manipulated to turn the device 110 on or off during each predetermined hour when the device 110 is a cooking heater.

FIG. 6A is a graph illustrating the number of times an ON manipulation has been performed during each predetermined hour, and FIG. 6B is a graph illustrating the number of times an OFF manipulation has been performed during each predetermined hour.

When the device-information analyzing unit 125 refers to graphs such as those in FIGS. 5A and 5B or FIGS. 6A and 6B and determines that the number of times a manipulation is performed exceeds a threshold, the device-information analyzing unit 125 can specify a manipulation pattern in which the manipulation is performed within the corresponding hour or at a time within the corresponding hour. The time within the hour may be at the beginning of the hour, during the hour, or at the end of the hour.

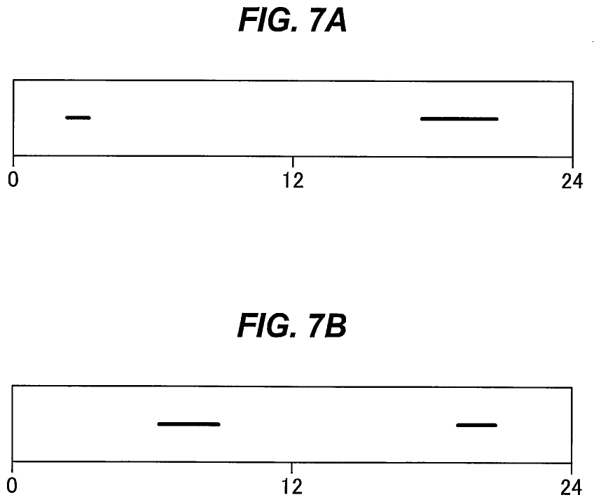

FIGS. 7A and 7B are graphs illustrating the operating times of an EcoCute heat pump and a cooking heater.

FIG. 7A is a graph illustrating the operating time of an EcoCute heat pump, and FIG. 7B is a graph illustrating the operating time of a cooking heater.

For example, the device-information analyzing unit 125 can specify a graph such as that in FIG. 7A by calculating the average operating time of the EcoCute heat pump from the time the EcoCute heat pump is turned on to the time it is turned off during a predetermined time period. The device-information analyzing unit 125 can specify a graph such as that in FIG. 7B by calculating the average operating time of the cooking heater from the time the cooking heater is turned on to the time it is turned off during a predetermined time period.

The device-information analyzing unit 125 can specify a manipulation pattern of a device 110 by referring to a corresponding graph such as that in FIG. 7A or 7B.

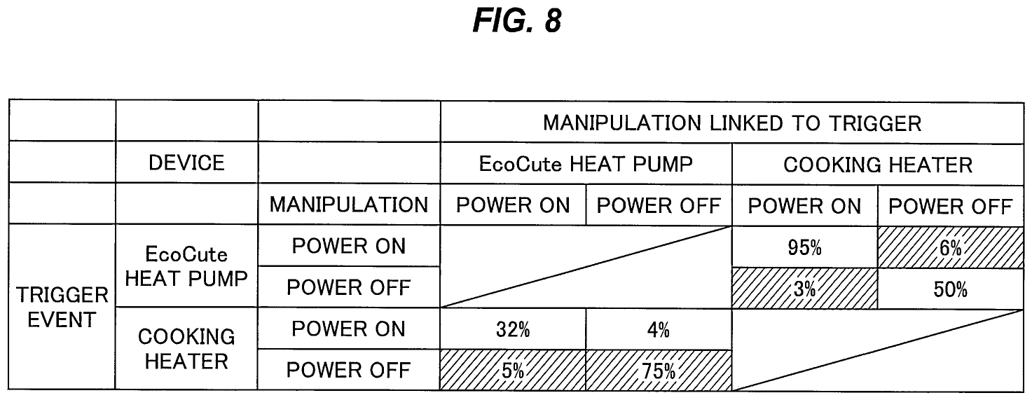

FIG. 8 is a table showing the probability of the manipulations of the devices 110 being linked to each other.

In FIG. 8, manipulations that are trigger events are turning on or off an EcoCute heat pump and turning on or off a cooking heater, and manipulations that are linked to triggers are turning on or off the EcoCute heat pump and turning on or off the cooking heater. FIG. 8 also shows the probability of a manipulation linked to a trigger manipulation being performed. The probability here is the ratio of the number of times a linked manipulation is performed during a predetermined time to the number of times a trigger manipulation is performed.

The device-information analyzing unit 125 refers to a table such as that in FIG. 8 to modify a manipulation pattern specified as described above so that the manipulation linked to a trigger manipulation is performed when the probability exceeds a threshold.

In such a case, a manipulation that is only performed for a small number of times but at a high probability after a certain manipulation can be included in the manipulation pattern.

Regression analysis may be used to calculate the probability of a manipulation of a device 110.

The movement-line-distance specifying unit 126 specifies the movement-line distances between devices 110 when the number of devices 110 is larger than one, and generates movement-line information that indicates the specified movement-line distances. For example, the movement-line-distance specifying unit 126 specifies the movement-line distance, which is the distance a user travels, for each combination of two devices 110 out of the multiple devices 110. The movement-line information is stored in the storage unit 123.

Here, the movement-line distance between devices 110 is not the linear distance between the devices 110 but is the distance required to travel by a user to manipulate the devices 110.

The movement-line distance may be input by a user via the input unit 122.

Alternatively, the movement-line-distance specifying unit 126 may specify the movement-line distance by acquiring a floor plan of the building in which the devices 110 are installed and the installation positions of the devices 110 via the communication unit 121 or the input unit 122. In this case, the movement-line-distance specifying unit 126 should specify the distance through doors, not through walls, as the movement-line distance.

If the user-information acquiring unit 127 acquires a user's step count and if it is determined from the device information acquired by the device-information acquiring unit 124 that two devices 110 have been manipulated, the movement-line-distance specifying unit 126 can estimate the movement-line distance between the two devices 110 on the basis of the number of steps taken by a user who has manipulated the two devices 110.

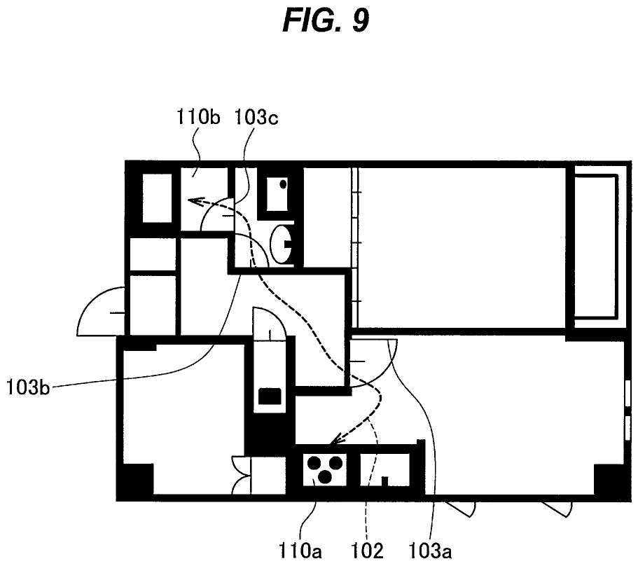

FIG. 9 is an example illustrating a movement line between devices 110.

FIG. 9 illustrates a movement line between a cooking heater 110a and an EcoCute heat pump 110b, as the devices 110.

As illustrated in FIG. 9, a movement line 102 represents a path traveled by a user from the cooking heater 110a to the EcoCute heat pump 110b through doors 103a, 103b, and 103c.

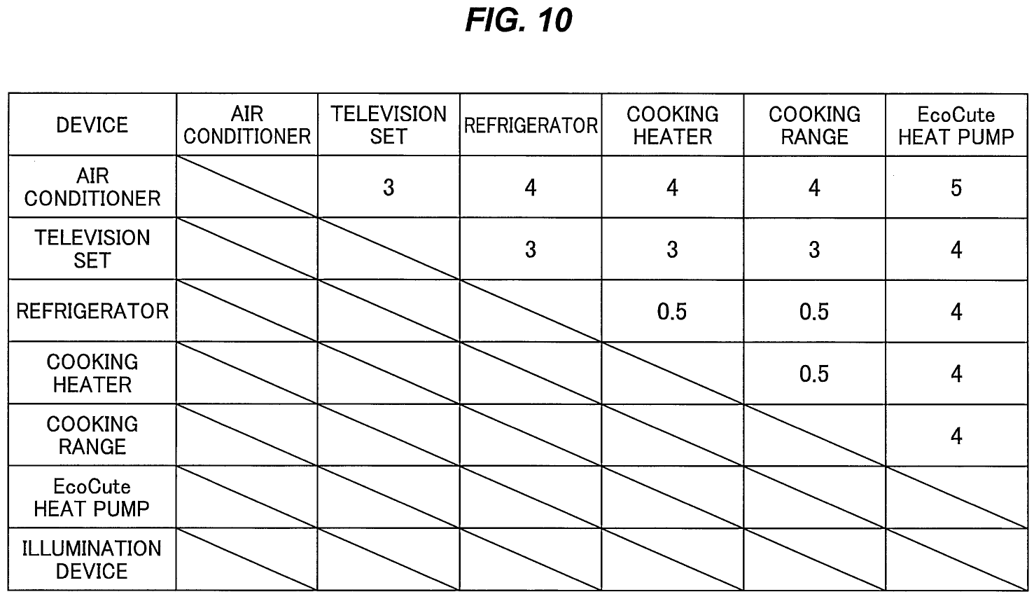

FIG. 10 is a schematic diagram illustrating an example of movement-line information.

As illustrated in FIG. 10, the movement-line information indicates movement-line distances between devices 110. In FIG. 10, the movement-line distances are expressed in units of meters.

Referring back to FIG. 3, the user-information acquiring unit 127 acquires user information indicating a user's state. User information contains information that can specify a user's age and whether the user is healthy or unhealthy, information that can specify the user's fatigue level, and information that can specify the user's step count.

Specifically, the user-information acquiring unit 127 acquires, as user information, user attributes that are attributes related to a user and user detection values that are physical quantities detected from the user, via the communication unit 121 or the input unit 122.

The user attributes are, for example, age and gender.

The user detection values are body temperature, heart rate, step count, etc. Respiratory rate may be used instead of heart rate. For heart rate and respiration rate, values at normal times and current values should be acquired. The normal values of the heart t rate or respiration rate may be acquired from a user via the input unit 122 or the communication unit 121 or may be estimated from the history of current values. A portion of the user detection values may be acquired from a wearable device or the like via the communication unit 121.

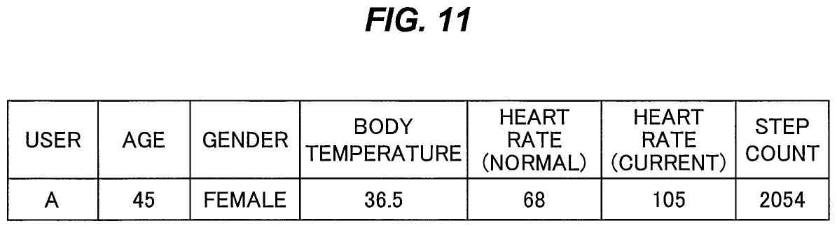

FIG. 11 is a schematic diagram illustrating an example of user information consisting of user attributes and user detection values.

Referring back to FIG. 3, the manipulation-order determining unit 128 determines a manipulation order of the devices 110. For example, the manipulation-order determining unit 128 determines an adopted manipulation order, or a chronological manipulation order of the devices 110, from the manipulation pattern specified by the device-information analyzing unit 125 so that the load on the user varies depending on the user's state.

Here, the manipulation-order determining unit 128 generates, from the manipulation pattern, a regular manipulation order, or a chronological order of manipulations of the devices s 110 by a user, generates, from the regular manipulation order, a light-load manipulation order, or a manipulation order that poses a lighter load on the user than the regular manipulation order, and generates, from the regular operation order, a heavy-load manipulation order, or a manipulation order that pose a heavier load on the user than the regular manipulation order. The manipulation-order determining unit 128 then selects one manipulation order from the regular manipulation order, the light-load manipulation order, and the heavy-load manipulation order in accordance with the user's state determines the selected manipulation order as the adopted manipulation order.

Specifically, the manipulation-order determining unit 128 generates regular manipulation order by combining the manipulation patterns of the respective devices 110 specified by the device-information analyzing unit 125. Since a manipulation pattern specifies the manipulations performed on each device 110 at each hour, the manipulation-order determining unit 128 can generate a regular manipulation order the by incorporating manipulation patterns of all devices 110 into the hours of the day.

The manipulation-order determining unit 128 then generates a light-load manipulation order, or a manipulation order that poses a lighter load on a user than a regular manipulation order.

The light-load manipulation order is, for example, a first light-load manipulation order having the shortest total movement-line distance by changing the order of manipulations included in the regular manipulation order, a second light-load manipulation order that includes the manipulations in the regular manipulation order except for the manipulations that are not necessarily required, and a third light-load manipulation order in which manipulations in the regular manipulation order that are preliminarily set to be automatically controlled are automatically performed.

In other words, the first light-load manipulation order is a manipulation order generated by changing the order of manipulations in included the regular manipulation order so that the total movement-line distance traveled by a user in the first light-load manipulation order is smaller than the total movement-line distance traveled by a user in the regular manipulation order. The second light-load manipulation order is a manipulation order generated by omitting at least one manipulation included in the regular manipulation order. The third light-load manipulation order is a manipulation order generated by automatically performing at least one manipulation included in the regular manipulation order.

For example, a user inputs via the input unit 122 which one of the first light-load manipulation order, the second light-load manipulation order, and the third light-load manipulation order is to be selected as the light-load manipulation order, and the selected manipulation order is used as the light-load manipulation order.

Manipulations that are not necessarily required should be set in advance by a user via the input unit 122.

The manipulation-order determining unit 128 may determine from the manipulation pattern information stored in the storage unit 123 that manipulations performed periodically, such as hourly, daily, weekly, or monthly, are required and that any other manipulations are not necessarily required. For example, when the ratio of the number of times a manipulation has been actually performed during a time period to the number of times a manipulation is assumed to be performed if the manipulation is performed periodically is greater than a predetermined threshold, the manipulation-order determining unit 128 should determine that the manipulation is performed periodically.

The manipulation-order determining unit 128 may determine manipulations correlated with conditions other than time, such as a manipulation that is not performed on a rainy day, a manipulation that is only performed when the temperature is high, or a manipulation that is only performed when a user is energetic, to be manipulations performed non-periodically and thus not necessarily required.

The manipulation-order determining unit 128 then generates a heavy-load manipulation order that is a manipulation order posing a heavier load on a user than a regular manipulation order.

For example, the manipulation-order determining unit 128 changes the order of manipulations included in a regular manipulation order to obtain a manipulation order having a movement-line distance closest to a target movement-line distance, which is obtained by adding a predetermined distance to the movement-line distance of the regular manipulation order, and determines the obtained manipulation order to be the heavy-load manipulation order. The distance to be added, for example, should be predetermined or may be accepted as an input from a user via the input unit 122.

In other words, a heavy-load manipulation order is a manipulation order generated by changing the order of manipulations included in a regular manipulation order so that the total movement-line distance of the heavy-load manipulation order traveled by a user is greater than the total movement-line distance of the regular manipulation order traveled by a user.

The manipulation-order determining unit 128 then specifies a user's age as condition A in the user attributes acquired by the user-information acquiring unit 127.

The manipulation-order determining unit 128 specifies the physical condition of a user from user detection values acquired by the user-information acquiring unit 127 and specifies a physical condition value, which is a value corresponding to the physical condition of the user, as condition B.

For example, the manipulation-order determining unit 128 specifies whether a user is healthy or unhealthy from the user detection values, and sets a predetermined first value as a health value when the user is healthy, and sets a predetermined second value as a health value when the user is unhealthy. Here, the first value is smaller than the second value.

Furthermore, the manipulation-order determining unit 128 specifies a fatigue level of a user from user detection values and sets a fatigue value that becomes larger as the fatigue level of the user increases. The manipulation-order determining unit 128 should determine that the fatigue level is high, for example, when the change in heart rate is great.

The manipulation-order determining unit 128 then should establish the sum of a health value and a fatigue value as a physical condition value.

The manipulation-order determining unit 128 specifies a physical strength value that becomes smaller as the physical strength of a user remains higher as condition C from the user detection values acquired by the user-information acquiring unit 127. For example, the manipulation-order determining unit 128 sets a fourth value as the physical strength value when a user's step count is less than normal, sets a fifth value as the physical strength value when a user's step count is normal, and sets a sixth value as the physical strength value when a user's step count is greater than normal. Here, the fourth value is smaller than the fifth value, and the fifth value is smaller than the sixth value. The manipulation-order determining unit 128 needs only to accept an input of the regular step count per day from a user via the input unit 122. The manipulation-order determining unit 128 may estimate the range of regular step counts on the basis of the history of user detection values. For example, the manipulation-order determining unit 128 may determine a user's average step count per day.

The manipulation-order determining unit 128 then divides the step count input by a user or the average step count with 24, which is the number of hours in a day, multiplies the resulting quotient with the current time, and adds and subtracts a predetermined step count to or from the resulting product, to obtain the range of regular step counts. In this case, if a user's step count is within the obtained range, the user's step count is normal; if the user's step count is less than the obtained range, the user's step count is less than normal; and if the user's step count is more than the obtained range, the user's step count is more than normal.

The manipulation-order determining unit 128 then calculates a manipulation-order determination coefficient K from the following equation (1).

$$K = condition A \times weighting a + condition B \times weighting b + condition C \times weighting c \qquad ( 1 )$$

where the weighting a, the weighting b, and the weighting c are predetermined weighting values and are assumed to be determined for each device 110.

The manipulation-order determining unit 128 determines an adopted manipulation order, which is a manipulation order to be adopted, in accordance with the value of the manipulation-order determination coefficient K.

For example, if a predetermined threshold is a threshold N, the manipulation-order determining unit 128 determines the regular manipulation order to be the adopted manipulation order when K=N, the light-load manipulation order to be the adopted manipulation order when K>N, and the heavy-load manipulation order to be the adopted manipulation order when K<N.

As described above, the older a user is, the more likely the manipulation-order determining unit 128 selects the light-load manipulation order as the adopted manipulation order, and the younger a user is, the more likely the manipulation-order determining unit 128 selects the heavy-load manipulation order as the adopted manipulation order. The manipulation-order determining unit 128 is more likely to select the light-load manipulation order as the adopted manipulation order when the user is unhealthy than when the user is healthy. The higher the fatigue level of a user is, the more likely the manipulation-order determining unit 128 selects the light-load manipulation order as the adopted manipulation order, and the lower the fatigue level of a user is, the more likely the manipulation-order determining unit 128 selects the heavy-load manipulation order as the adopted manipulation order. In addition, the greater a user s step count is, the more likely the manipulation-order determining unit 128 selects the light-load manipulation order as the adopted manipulation order, and the smaller a user's step count is, the more likely the manipulation-order determining unit 128 selects the heavy-load manipulation order as the adopted manipulation order.

The output unit 129 outputs the determined adopted manipulation order. Here, the output unit 129 functions as a display unit for displaying various screen images, and the output unit 129 displays the determined adopted manipulation order to the user.

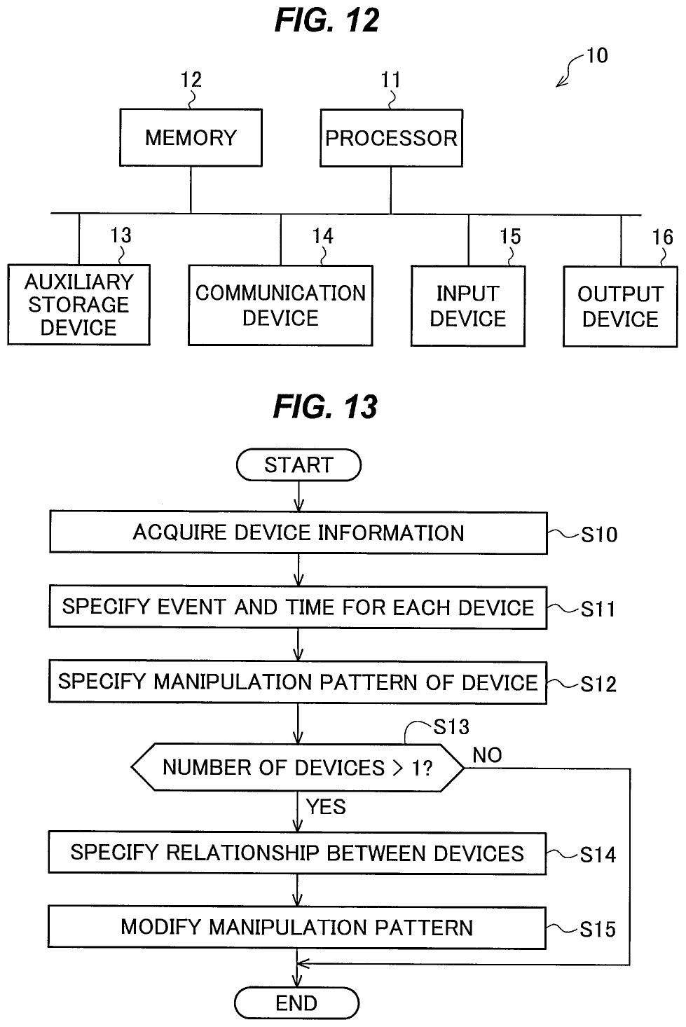

The device control apparatus 120 described above can be implemented by, for example, a computer 10, as illustrated in FIG. 12.

The computer 10 includes a processor 11, such as a central processing unit (CPU), a memory 12, an auxiliary storage device 13, such as a hard disk drive (HDD), a communication device 14, such as a network interface card (NIC) for communication, an input device 15, such as a keyboard or mouse, and an output device 16, such as a speaker or display.

For example, the communication unit 121 can be implemented by the communication device 14, the input unit 122 can be implemented by the input device 15, and the output unit 129 can be implemented by the output device 16.

The device-information acquiring unit 124, the device-information analyzing unit 125, the movement-line-distance specifying unit 126, the user-information acquiring unit 127, and the manipulation-order determining unit 128 can be implemented by the processor 11 loading programs stored in the auxiliary storage device 13 to the memory 12 and executing the programs.

Such programs may be provided over a network or may be recorded and provided on a recording medium. That is, such programs may be provided, for example, as a program product.

The operation of the device control apparatus 120 will now be explained.

FIG. 13 is a flowchart illustrating processing executed by the device-information acquiring unit 124 and the device-information analyzing unit 125.

First, the device-information acquiring unit 124 acquires device information from the devices 110 via the communication unit 121 (step S10). The acquired device information is given to the device-information analyzing unit 125.

The device-information analyzing unit 125 analyzes the device information from the device-information acquiring unit 124 to specify events and their times and stores device identification information, or identification information for identifying the devices 110, and event information indicating the events and their times in the storage unit 123 (step S11).

The device-information analyzing unit 125 refers to the event information stored in the storage unit 123 and aggregates the number of times a manipulation is performed during each predetermined hour in predetermined time period for each device 110, to specify manipulation pattern for each device 110 (step S12). The device-information analyzing unit 125 then stores manipulation pattern information indicating the specified manipulation pattern in the storage unit 123.

Next, the device-information analyzing unit 125 determines whether or not the number of devices 110 connected to the network 101 is more than one (step S13). If the number of devices 110 connected to the network 101 is more than one (Yes in step S13), the process proceeds to step S14; and if the number of devices 110 connected to the network 101 is one (No in step S13), and the process ends.

In step S14, the device-information analyzing unit 125 refers to the event information stored in the storage unit 123 to determine the probability of a manipulation linked to a trigger manipulation being performed, and thereby specifies the relationship between the devices 110.

The device-information analyzing unit 125 then modifies the manipulation pattern specified in step S12, if necessary, on the basis of the relationship specified in step S14 (step S15). For example, when the manipulation pattern does not include a linked manipulation whose probability determined in step S14 exceeds a threshold, the linked manipulation is included in the manipulation pattern after a trigger manipulation is performed.

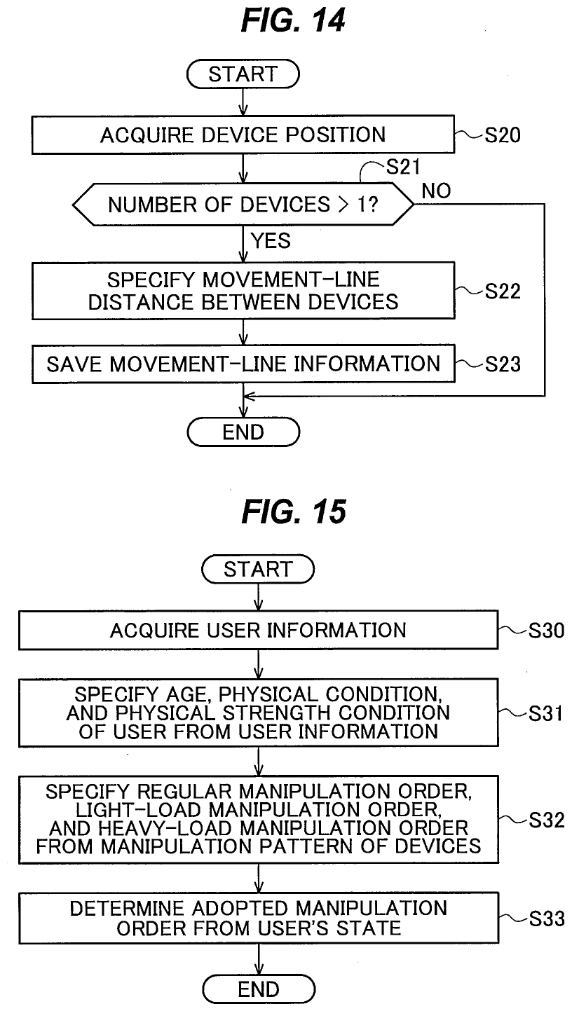

FIG. 14 is a flowchart illustrating processing executed by the movement-line-distance specifying unit 126.

Here, an example is explained for obtaining a movement-line distance by using a floor plan of a building and installation positions of the devices 110.

First, the movement-line-distance specifying unit 126 acquires a floor plan of the building in which the devices 110 are installed and the installation positions of the devices 110 via the communication unit 121 or the input unit 122 (step S20).

Next, the movement-line-distance specifying unit 126 determines whether or not the number of devices 110 connected to the network 101 is more than one (step S21). If the number of devices 110 connected to the network 101 is more than one (Yes in step S21), the process proceeds to step S22; and if the number of devices 110 connected to the network 101 is one (No in step S21), the process ends.

In step S22, the movement-line-distance specifying unit 126 specifies a movement-line distance between two devices 110 that can be selected from the multiple devices 110 on the basis of the floor plan of the building in which the devices 110 are installed and the installation positions of the devices 110 (step S22).

The movement-line-distance specifying unit 126 generates movement-line information indicating the specified movement-line distance and stores the movement-line information in the storage unit 123 (step S23).

FIG. 15 is a flowchart illustrating processing executed by the user-information acquiring unit 127 and the manipulation-order determining unit 128.

First, the user-information acquiring unit 127 acquires, as user information, user attributes that are attributes related to a user and user detection values that are physical quantities detected from the user, via the communication unit 121 or the input unit 122 (step S30). The acquired user information is given to the manipulation-order determining unit 128.

The manipulation-order determining unit 128 specifies the age, physical condition, and physical strength condition of the user on the basis of the user information from the user-information acquiring unit 127 (step S31).

The manipulation-order determining unit 128 specifies a regular manipulation order, a light-load manipulation order, and a heavy-load manipulation order from the manipulation patterns of the devices 110 specified by the device-information analyzing unit 125 (step S32).

The manipulation-order determining unit 128 then determines one of the regular manipulation order, the light-load manipulation order, and the heavy-load manipulation order on the basis of the user's state, such as age, physical condition, and physical strength condition, as an adopted manipulation order adopted as a manipulation order of the devices 110 (step S33).

Accordingly, for example, if the user is as energetic as usual, the regular manipulation order is more likely to be adopted without changing the usual order performed by the user.

In contrast, if the user is in a fatigued state, the light-load manipulation order is more likely to be adopted, which is a manipulation order in which automatic control is performed on behalf of the user or in which a manipulation is not performed for a device that is not necessarily required. If the user is older, the light-load manipulation order is more likely to be adopted.

Moreover, if the user's step count is less than usual and the user's physical strength remains at a certain level, the heavy-load manipulation order is more likely to be adopted in which the movement-line distance traveled by the user is long. If the user is young, the heavy-load manipulation order is more likely to be adopted.

As described above, according to the first embodiment, it is possible to adopt a manipulation order corresponding to the lifestyle pattern of a user and the state of the user. Therefore, it is possible to determine device control in accordance with the user attributes or the real-time state of the user in consideration of the movement line traveled by the user.

Furthermore, according to the first embodiment, it is possible to achieve the effect of improving health care for a user by not only pursuing comfort but also eliminating the user's lack of exercise or making a recommendation to rest.

According to the first embodiment, by considering the user attributes, it is possible to determine device control in a static state, and by considering the state of the user, it is possible to determine dynamic device control.

The user's fatigue level can be detected, for example, by the ratio of a low frequency component to a high frequency component obtained by performing heart-rate variability analysis.

### Second Embodiment

As illustrated in FIG. 1, a device control system 200 according to the second embodiment includes one or more devices 110 and a device control apparatus 220 according to the second embodiment.

The devices 110 and the device control apparatus 220 are connected to the network 101.

The devices 110 according to the second embodiment are the same as the devices 110 according to the first embodiment.

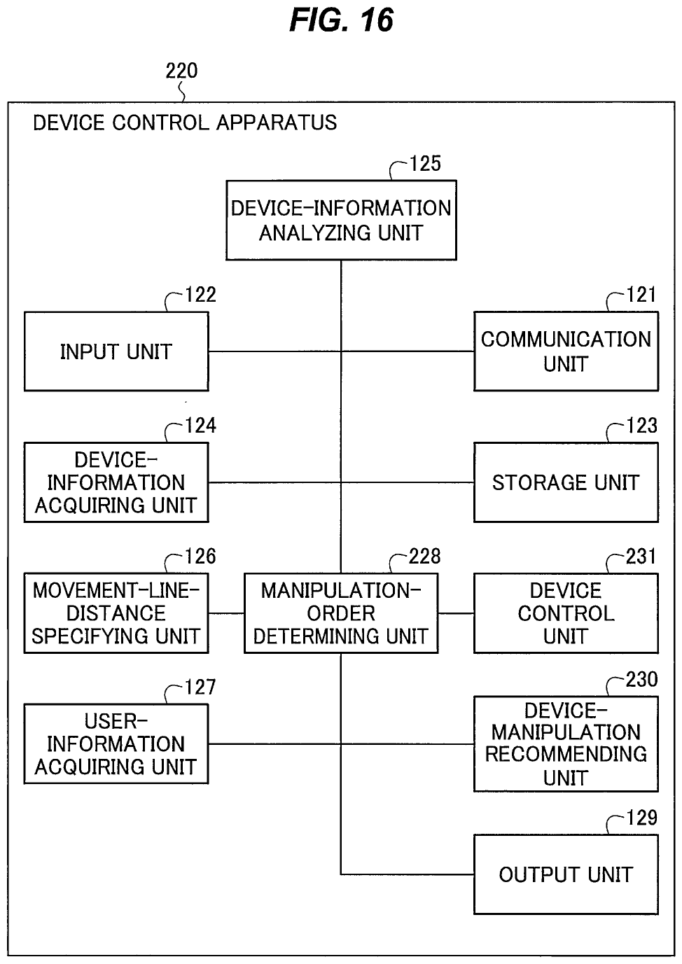

FIG. 16 is a block diagram illustrating a configuration of the device control apparatus 220 according to the second embodiment.

The device control apparatus 220 includes a communication unit 121, an input unit 122, a storage unit 123, a device-information acquiring unit 124, a device-information analyzing unit 125, a movement-line-distance specifying unit 126, a user-information acquiring unit 127, a manipulation-order determining unit 228, an output unit 129, a device-manipulation recommending unit 230, and a device control unit 231.

The communication unit 121, the input unit 122, the storage unit 123, the device-information acquiring unit 124, the device-information analyzing unit 125, the movement-line-distance specifying unit 126, the user-information acquiring unit 127, and the output unit 129 of the device control apparatus 220 according to the second embodiment are respectively the same as the communication unit 121, the input unit 122, the storage unit 123, the device-information acquiring 124, unit the device-information analyzing unit 125, the movement-line-distance specifying unit 126, the user-information acquiring unit 127, and the output unit 129 of the device control apparatus 120 according to the first embodiment.

The manipulation-order determining unit 228 determines an adopted manipulation order in the same manner as the manipulation-order determining unit 128 of the first embodiment and notifies the device-manipulation recommending unit 230 of the determined adopted manipulation order.

When the device-manipulation recommending unit 230 recommends an adopted manipulation order to a user as described later, the manipulation-order determining unit 228 feeds back the user's response to the determination of the adopted manipulation order. For example, the manipulation-order determining unit 228 modifies the values of the weighting a, the weighting b, and the weighting c in equation (1), which is the calculation formula of the manipulation-order determination coefficient K, in accordance with the user's response to the recommended adopted manipulation order.

Specifically, when a regular manipulation order is the determined as the adopted manipulation order, manipulation-order determining unit 228 does not modify the values of the weighting a, the weighting b, and the weighting c in equation (1).

When the light-load manipulation order is determined as the adopted manipulation order, the manipulation-order determining unit 228 increases the values of the weighting a, the weighting b, and the weighting c in equation (1) to facilitate the adoption of the light-load manipulation order when the user performs the manipulations as recommended. For example, the manipulation-order determining unit 228 multiplies the weighting a, the weighting b, and the weighting c by a feedback value V that satisfies 1<V<2. When the light-load manipulation order is determined as the adopted manipulation order, the manipulation-order determining unit 228 decreases the values of the weighting a, the weighting b, and the weighting c in equation (1) to hinder the adoption of the light-load manipulation order when the user does not perform the manipulations as recommended. For example, the manipulation-order determining unit 228 multiplies the weighting a, the weighting b, and the weighting c by a feedback value V that satisfies 0<V<1.

When the heavy-load manipulation order is determined as the adopted manipulation order, the manipulation-order determining unit 228 decreases the values of the weighting a, the weighting b, and the weighting c in equation (1) to facilitate the adoption of the heavy-load manipulation order when the user performs the manipulations as recommended. For example, the manipulation-order determining unit 228 multiplies the weighting a, the weighting b, and the weighting c by a feedback value V that satisfies 0<V<1. When the heavy-load manipulation order is determined as the adopted manipulation order, the manipulation-order determining unit 228 increases the values of the weighting a, the weighting b, and the weighting c in equation (1) to hinder the adoption of the heavy-load manipulation order when the user does not perform the manipulations as recommended. For example, the manipulation-order determining unit 228 multiplies the weighting a, the weighting b, and the weighting c by a feedback value V that satisfies 1<V<2.

The manipulation-order determining unit 228 needs only to grasp whether or not a user has performed the manipulations as recommended, for example, by accepting input to the input unit 122 from the user. The manipulation-order determining unit 228 may also determine that a user has performed the manipulations as recommended when information indicating that the manipulations recommended by the device-information acquiring unit 124 have been performed is acquired within a predetermined time period after a recommendation to the user has been made.

The device-manipulation recommending unit 230 causes the output unit 129 to output a recommendation to perform the corresponding manipulations in accordance with the chronological sequence of the adopted manipulation order.

For example, the device-manipulation recommending unit 230 causes the output unit 129 to display a screen image that recommends performing a manipulation at the time of performing the manipulation in accordance with the adopted manipulation order.

Here, the device-manipulation recommending unit 230 causes the output unit 129 to display a screen image inquiring a user about whether or not to perform a manipulation under automatic control if the adopted manipulation order indicates that the manipulation is to be performed under automatic control; and if the user responds that the manipulation is to be performed by the user, the device-manipulation recommending unit 230 instructs the device control unit 231 to cause a target device 110 to perform the operation that is to be performed in response to such a manipulation.

The device control unit 231 sends a command to the target device 110 via the communication unit 121 in response to an instruction from the device-manipulation recommending unit 230 to cause the target device 110 to execute control in response to a target manipulation. The device 110 that has received such a command executes control in response to the target manipulation in accordance with the command.

In other words, the device control unit 231 provides input indicating that a user is going to execute a corresponding manipulation to the input unit 122, and causes the target device 110 of the corresponding manipulation to execute control in response to the corresponding manipulation when the corresponding manipulation is to be performed automatically.

The device-manipulation recommending unit 230 and the device control unit 231 described above can also be implemented by the processor 11 loading the programs stored in the auxiliary storage device 13 to the memory 12 and executing the programs, as illustrated in FIG. 12.

As described above, according to the second embodiment, a user can be notified to perform manipulations in accordance with a determined adopted manipulation order.

In the second embodiment, the device-manipulation recommending unit 230 inquires a user about whether or not a manipulation is to be performed under automatic control at the time when the manipulation is to be performed, but the second embodiment is not limited to such an example. For example, if a user has preliminarily set the device control apparatus 220 to perform a manipulation under automatic control, the device-manipulation recommending unit 230 instructs the device control unit 231 to control the target device 110 to execute such a manipulation at the time the manipulation is to be performed under automatic control.

### Third Embodiment

As illustrated in FIG. 1, a device control system 300 according to the third embodiment includes one or more devices 110 and a device control apparatus 320 according to the third embodiment.

The devices 110 and the device control apparatus 320 are connected to the network 101.

The devices 110 according to the third embodiment are the same as the devices 110 according to the first embodiment.

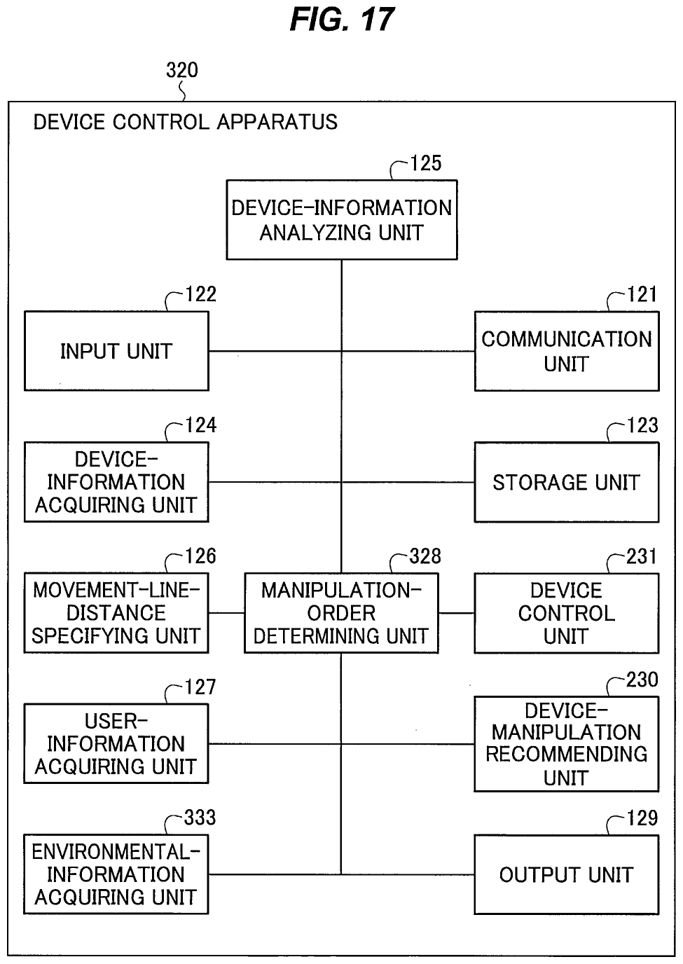

FIG. 17 is a block diagram illustrating a configuration of the device control apparatus 320 according to the third embodiment.

The device control apparatus 320 includes a communication unit 121, an input unit 122, a storage unit 123, a device-information acquiring unit 124, a device-information analyzing unit 125, a movement-line-distance specifying unit 126, a user-information acquiring unit 127, a manipulation-order determining unit 328, an output unit 129, a device-manipulation recommending unit 230, a device control 231, and an environmental-information acquiring unit 333.

The communication unit 121, the input unit 122, the storage unit 123, the device-information acquiring unit 124, the device-information analyzing unit 125, the movement-line-distance specifying unit 126, the user-information acquiring unit 127, and the output unit 129 of the device control apparatus 320 according to the third embodiment are respectively the same as the communication unit 121, the input unit 122, the storage unit 123, the device-information acquiring unit 124, the device-information analyzing unit 125, the movement-line-distance specifying unit 126, the user-information acquiring unit 127, and the output unit 129 of the device control apparatus 120 according to the first embodiment.

The device-manipulation recommending unit 230 and the device control unit 231 of the device control apparatus 320 according to the third embodiment are respectively the same as the device-manipulation recommending unit 230 and the device control unit 231 of the device control apparatus 220 according to the second embodiment.

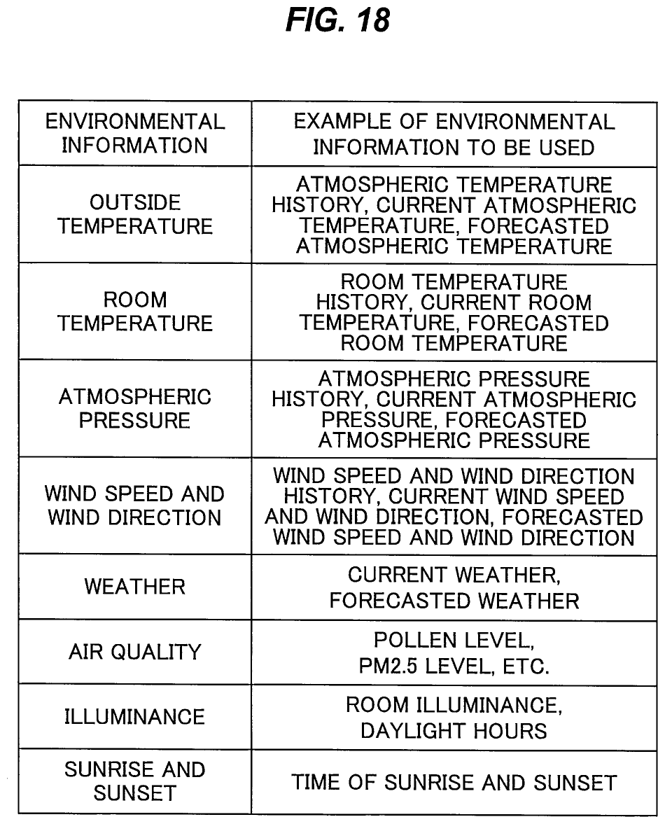

The environmental-information acquiring unit 333 acquires environmental information indicating physical quantities related to the environment of the devices 110 via the communication unit 121 or the input unit 122. An example of environmental information used in the third embodiment is illustrated in FIG. 18.

The environmental information may be acquired, for example, from sensors provided in the devices 110, or otherwise may be acquired from an independent sensor or an external unit via the Internet. The acquired environmental information is given to the manipulation-order determining unit 328.

The manipulation-order determining unit 328 determines a manipulation order for the devices 110. For example, the manipulation-order determining unit 328 determines an adopted manipulation order, or a chronological manipulation order of the devices 110, from the manipulation pattern specified by the device-information analyzing unit 125 and the environmental information acquired by the environmental-information acquiring unit 333 so that the load on the user varies depending on the user's state and the physical quantities indicated by the environmental information.

Specifically, the manipulation-order determining unit 328 calculates a manipulation-order determination coefficient K from the following equation (2).

$$K = condition A \times weighting a + condition B \times weighting b + condition C \times weighting c + condition D \times weighting d \qquad ( 2 )$$

where condition A, condition B, condition C, weighting a, weighting b, and weighting c are the same as those in equation (1) above.

Condition D is a value determined by environmental information. For example, condition D should be calculated through multiple regression analysis as an objective variable indicating to what extent user's behavior is affected, where temperature, humidity, pressure, and weather are explanatory variables.

The weighting d is a predetermined weight value and should be determined for each device 110.

The manipulation-order determining unit 328 then determines an adopted manipulation order, which is a manipulation order to be adopted, in accordance with the value of the manipulation-order determination coefficient K, as in the first embodiment. For example, if a predetermined threshold is a threshold N, the manipulation-order determining unit 328 determines the regular manipulation order to be the adopted manipulation order when K=N, the light-load manipulation order to be the adopted manipulation order when K>N, and the heavy-load manipulation order to be the adopted manipulation order when K<N. The regular manipulation order, the light-load manipulation order, and the heavy-load manipulation order are the same as those in the first embodiment.

Furthermore, when the device-manipulation recommending unit 230 recommends an adopted manipulation order to a user, the manipulation-order determining unit 328 feeds back the user's response to the determination of the adopted manipulation order. For example, the manipulation-order determining unit 328 modifies the values of the weighting a, the weighting b, the weighting c, and the weighting d in equation (2), which is the calculation formula of the manipulation-order determination coefficient K, in accordance with the user's response to the recommended adopted manipulation order. The method for modifying the weighting values is the same as that of the second embodiment.

As described above, according to the third embodiment, for example, the manipulation order can be determined in consideration of a poor physical condition due to a sudden change in atmospheric pressure or the like in addition to the device states, the movement-line information, and the user information. It is also possible to execute device control for preventing poor physical conditions due to a difference in cold and warm temperatures. It is also possible to determine device manipulations and device control that correspond to changes in an autonomic nervous balance due to daylight hours.

In the first to third embodiments described above, each of the device control apparatuses 120, 220, and 320 includes the input unit 122 and the output unit 129, but the first to third embodiments are not limited to such examples. At least one of the input unit 122 and the output unit 129 may not be provided in each of the device control apparatuses 120, 220, and 320. In such a case, for example, an input unit or an output unit of another device connected to the network 101 via the communication unit 121 may be used. If at least one of the input unit 122 and the output unit 129 is not provided in each of the device control apparatuses 120, 220, and 320, at least one of the input device 15 and the output device 16 may also not be provided in the computer 10 illustrated in FIG. 12.

For example, in the first to third embodiments described above, the output unit 129 displays an adopted manipulation order to indicate the determined adopted manipulation order to a user, but the first to third embodiments are not limited to such examples. For example, the output unit 129 may output an adopted manipulation order by voice. In the second or third embodiment, the output unit 129 may output a recommendation in voice to perform corresponding manipulations in accordance with the chronological sequence of the adopted manipulation order.

Some or all of the functional units of each of the device control apparatuses 120, 220, and 320 may be implemented by a cloud on the Internet.

### DESCRIPTION OF REFERENCE CHARACTERS

100, 200, 300 device control system; 110 device; 120, 220, 320 device control apparatus; 121 communication unit; 122 input unit; 123 storage unit; 124 device-information acquiring unit; 125 device-information analyzing unit; 126 movement-line-distance specifying unit; 127 user-information acquiring unit; 128, 228, 328 manipulation-order determining unit; 129 output unit; 230 device-manipulation recommending unit; 231 device control unit; 333 environmental-information acquiring unit.

1. An information processing apparatus comprising:
a processor to execute a program; and
a memory to store the program which, when executed by the processor, performs processes of,
acquiring device information indicating at least manipulations performed by a user from one or more devices;
analyzing the device information to specify a manipulation pattern, the manipulation pattern being a pattern in which the one or more devices are manipulated in a chronological sequence;
acquiring user information indicating a state of the user; and
determining an adopted manipulation order as a manipulation order from the manipulation pattern in such a manner that load on the user changes depending on the state of the user, the manipulation order being an order of manipulations to be performed in a chronological sequence on the one or more devices.

2. The information processing apparatus according to claim 1, wherein the processor
generates a regular manipulation order from the manipulation pattern, the regular manipulation order being an order of manipulations to be performed in a chronological sequence on the one or more devices by the user,
generates a light-load manipulation order from the regular manipulation order, the light-load manipulation order being a manipulation order in which the load on the user is smaller than the regular manipulation order,
generates a heavy-load manipulation order from the regular manipulation order, the heavy-load manipulation order being a manipulation order in which the load on the user is larger than the regular manipulation order,
selects one manipulation order from the regular manipulation order, the light-load manipulation order, and the heavy-load manipulation order in accordance with the state of the user, and
determines the selected manipulation order as the adopted manipulation order.

3. The information processing apparatus according to claim 2, wherein,
the user information indicates at least an age of the user, and
the processor is more likely to select the light-load manipulation order as the adopted manipulation order when the age of the user is higher and is more likely to select the heavy-load manipulation order as the adopted manipulation order when the age of the user is lower.

4. The information processing apparatus according to claim 2, wherein,
the user information at least includes information capable of specifying whether the user is healthy or unhealthy, and
the processor is more likely to select the light-load manipulation order as the adopted manipulation order when the user is unhealthy than when the user is healthy.

5. The information processing apparatus according to claim 2, wherein,
the user information at least includes information capable of specifying a fatigue level of the user, and
the processor is more likely to select the light-load manipulation order as the adopted manipulation order when the fatigue level of the user is higher and is more likely to select the heavy-load manipulation order as the adopted manipulation order when the fatigue level of the user is lower.

6. The information processing apparatus according to claim 2, wherein,
the user information at least includes information capable of specifying a step count of the user, and
the processor is more likely to select the light-load manipulation order as the adopted manipulation order when the step count of the user is higher and is more likely to select the heavy-load manipulation order as the adopted manipulation order when the step count of the user is lower.

7. The information processing apparatus according to claim 2, wherein the processor generates the light-load manipulation order by omitting at least one manipulation included in the regular manipulation order.

8. The information processing apparatus according to claim 2, wherein the processor generates the light-load manipulation order by automatically performing at least one manipulation included in the regular manipulation order.

9. The information processing apparatus according to claim 2, wherein the processor
specifies a movement-line distance for each combination of two of the devices and
generates the light-load manipulation order by changing the sequence of the manipulations in the regular manipulation order in such a manner that the total movement-line distance traveled by the user for the light-load manipulation order is smaller than the total movement-line distance traveled by the user for the regular manipulation order, the movement-line distance being a distance traveled by the user.

10. The information processing apparatus according to claim 2, wherein the processor
specifies a movement-line distance for each combination of two of the devices and
generates the heavy-load manipulation order by changing the sequence of the manipulations in the regular manipulation order in such a manner that the total movement-line distance traveled by the user for the heavy-load manipulation order is larger than the total movement-line distance traveled by the user for the regular manipulation order, the movement-line distance being a distance traveled by the user.

11. The information processing apparatus according to claim 1, wherein the processor outputs the adopted manipulation order.

12. The information processing apparatus according claim 1, wherein the processor provides an output recommending to perform corresponding manipulations in accordance with a chronological sequence of the adopted manipulation order, and
feeds back a response of a user to the output to determination of the adopted manipulation order.

13. The information processing apparatus according to claim 1, wherein the processor accepts input from the user,
provides an output recommending to perform corresponding manipulations in accordance with a chronological sequence of the adopted manipulation order,
and causes a target device of the corresponding manipulations out of the one or more devices to execute control for the corresponding manipulations when input indicating that the user is to perform the corresponding manipulations is made and the corresponding manipulations are to be performed automatically.

14. The information processing apparatus according to claim 1, wherein the processor acquires environmental information indicating a physical quantity related to an environment of the one or more devices
and determines the adopted manipulation order based on the manipulation pattern and the environmental information in such a manner that load on the user varies in accordance with the state of the user and the physical quantity.

15. A non-transitory computer-readable medium that stores therein a program that causes a computer to execute processes of:
acquiring device information indicating at least manipulations performed by a user from one or more devices;
analyzing the device information to specify a manipulation pattern being a pattern in which the one or more devices are manipulated in a chronological sequence;
acquiring user information indicating a state of the user; and
determining an adopted manipulation order as a manipulation order from the manipulation pattern in such a manner that load on the user changes depending on the state of the user, the manipulation order being an order of manipulations to be performed in a chronological sequence on the one or more devices.

16. An information processing method comprising:
acquiring device information indicating at least manipulations performed by a user from one or more devices;
analyzing the device information to specify a manipulation pattern being a pattern in which the one or more devices are manipulated in a chronological sequence;
acquiring user information indicating a state of the user, and
determining an adopted manipulation order as a manipulation order from the manipulation pattern in such a manner that load on the user changes depending on the state of the user, the manipulation order being an order of manipulations to be performed in a chronological sequence on the one or more devices.
